(19) United States
(12) Patent Application Publication
(10) Pub. No.: US 2026/0302059 A1
(43) Pub. Date: Oct. 1, 2026

(54) METHOD FOR FABRICATING INDUCTORS AND INDUCTOR

(71) Applicants: ANHUI UNIVERSITY, Hefei City (CN); Jiangsu Lanpe New Materials Technology Co., Ltd, Wuxi City (CN)

(72) Inventors: Pengpeng Chen, Wuxi City (CN); Tao Lin, Wuxi City (CN); Wei Wang, Wuxi City (CN); Dingming Ge, Wuxi City (CN); Zhenglong Li, Wuxi City (CN)

(21) Appl. No.: 19/458,687

(22) Filed: Jan. 24, 2026

Related U.S. Application Data
(63) Continuation of application No. PCT/CN2025/112377, filed on Aug. 4, 2025.

(30) Foreign Application Priority Data
Mar. 28, 2025 (CN) 202510377275.5

(51) Int. Cl. H01F 41/02; H01F 1/147; H01F 1/33; H01F 3/08; H01F 5/02; H01F 37/00; H01F 41/098

(52) U.S. Cl. CPC H01F 41/0246; H01F 1/147; H01F 1/33; H01F 3/08; H01F 5/02; H01F 37/00; H01F 41/098

(57) ABSTRACT

Disclosed are a method for fabricating inductors and an inductor. A first soft magnetic powder, a second soft magnetic powder, and a third soft magnetic powder are separately prepared, and a base, a center post, and a top cover are fabricated from these three soft magnetic powders. The base has an accommodating cavity, and the top cover seals the accommodating cavity. A hollow coil is winded, the base is placed into a forming mold, the center post and the hollow coil are placed into the accommodating cavity, the hollow coil is sleeved onto the center post, the top cover is placed into the forming mold, and a hot-pressing operation is performed in the forming mold to yield an inductor. By pre-pressing the soft magnetic powder and then performing hot-pressing with a hollow coil, the powder is prevented from piercing the insulation layer of the coil.

### CROSS REFERENCE TO THE RELATED APPLICATIONS

This application is a continuation of International Application No. PCT/CN2025/112377, filed on Aug. 4, 2025, which claims priority to Chinese Patent Application No. 202510377275.5, filed on Mar. 28, 2025. The disclosures of the aforementioned applications are hereby incorporated by reference in their entireties.

### TECHNICAL FIELD

The present disclosure relates to the technical field of fabrication of electronic components, and in particular, relates to a method for fabricating inductors and an inductor.

### BACKGROUND

An inductor is an electrical component used to increase magnetic flux to add inductance to a circuit, thereby implementing functions such as filtering, oscillating, delaying, and notching. An inductor typically consists of a conductive wire wound into a coil and a magnetic material.

Currently, inductors are commonly fabricated by a one-piece molding process. This process involves first winding a hollow coil, placing the hollow coil into a pressing mold, and then filling the pressing mold with magnetic powder. The magnetic powder and the hollow coil are then pressed into a final shape in a single step using mechanical pressure to obtain the inductor.

However, during the pressing operation, it is possible that the magnetic powder flow into an interior of the coil and pierce an insulation layer of the coil, leading to short-circuit conditions. This results in poor performance of the fabricated inductor.

### SUMMARY

Embodiments of the present disclosure provide a method for fabricating inductors and an inductor. By pre-pressing a magnetic powder to form molded parts, which are then hot-pressed together with a coil to form the inductor, the present disclosure addresses the problem that, during pressing, the magnetic powder may flow into an interior of the coil, piercing an insulation layer of the coil and leading to a short-circuit and resulting in poor performance of the fabricated inductor. The performance of the inductor is thereby improved.

In a first aspect, the embodiments of the present disclosure provide a method for fabricating inductors. The method includes:
preparing a first soft magnetic powder, a second soft magnetic powder, and a third soft magnetic powder separately;
placing the first soft magnetic powder into a base mold and performing a pressing operation to form a base, placing the second soft magnetic powder into a center post mold and performing a pressing operation to form a center post, and placing the third soft magnetic powder into a top cover mold and performing a pressing operation to form a top cover; wherein the base is U-shaped and defines an accommodating cavity, and the top cover is configured to seal the accommodating cavity to wrap the hollow coil;
winding a hollow coil; and
placing the base into a forming mold, placing the center post and the hollow coil into the accommodating cavity, sleeving the hollow coil onto the center post, placing the top cover into the forming mold such that the top cover is abutted against a top surface of the base, a top surface of the center post, and a top surface of the hollow coil, and performing a hot-pressing operation in the forming mold to yield an inductor.

In some embodiments, for the each pressing operation, a pressure per unit area is from 20 kg/mm² to 60 kg/mm², a mold cavity temperature is from 20° C. to 100° C., and a pressing time is from 0.1 s to 1 s.

In some embodiments, the pressure per unit area is 40 kg/mm², the mold cavity temperature is 30° C., and the pressing time is 0.3 s, such that a density of the base, the center post, and the top cover formed by the pressing operation is in a range of 5.5 g/mm³ to 6.5 g/mm³.

In some embodiments, for the hot-pressing operation, a pressure per unit area is from 40 kg/mm² to 80 kg/mm², a mold cavity temperature is from 150° C. to 220° C., and a pressing time is from 40 s to 120 s.

In some embodiments, winding the hollow coil includes:
winding the hollow coil on a metal sleeve by interpolation winding, wherein a diameter of the metal sleeve is greater than a diameter of the center post.

In some embodiments, each of the first soft magnetic powder, the second soft magnetic powder, and the third soft magnetic powder includes a resin material and a soft magnetic metal material, wherein the target soft magnetic powder includes one or more from a group of the first soft magnetic powder, the second soft magnetic powder, and the third soft magnetic powder; wherein the resin material comprises one or more selected from the group consisting of an epoxy resin, an amino resin, a polyamide resin, and a phenolic resin; and the soft magnetic metal material comprises one or more selected from the group consisting of a carbonyl iron powder, an iron-silicon-aluminum powder, an iron-silicon powder, an iron-nickel powder, an iron-nickel-molybdenum powder, an amorphous powder, and a nanocrystalline powder.

In some embodiments, by weight, a content of the resin material is from 1% to 10%.

In some embodiments, a wall thickness of the base is greater than or equal to 50 μm, a bottom thickness of the base is greater than or equal to 150 μm, and a thickness of a thinnest part of the top cover is greater than or equal to 150 μm.

By the method according to the first aspect, the first soft magnetic powder, the second soft magnetic powder, and the third soft magnetic powder are separately prepared, and the base, the center post, and the top cover are fabricated from these three soft magnetic powders. This facilitates the optimization of the performance of the inductor, allows for customized design, and is also conducive to balancing performance and cost. By pre-pressing the soft magnetic powder, the base, the center post, and the top cover may be yielded. Furthermore, dividing the magnetic core into the three parts of the base, the center post, and the top cover also allows for pressing under different conditions to ensure that the density and performance of each part are optimized, which is conducive to improving the performance of the inductor. The base, the center post, the hollow coil, and the top cover are combined via the hot-pressing operation to form the inductor. During the hot-pressing process, since the base, the center post, and the top cover are parts pre-pressed from the soft magnetic powder, the soft magnetic material may not flow during the hot-pressing operation. The hollow coil may not come into contact with the soft magnetic powder in a powdered state, such that the probability that the soft magnetic powder pierces the hollow coil is reduced, the occurrence of short circuits is avoided, and the performance of the inductor is improved.

Furthermore, the pre-pressed and formed soft magnetic material parts undergo another hot-pressing step. The density is increased after the hot-pressing. For the same volume, this can increase the inductance value of the inductor, thereby further improving the inductor's performance. Moreover, since the base, the center post, and the top cover are pre-pressed soft magnetic material parts, they may act to hinder the deformation of the hollow coil during hot pressing, thereby reducing the impedance of the inductor and improving its performance.

In a second aspect, the embodiments of the present disclosure provide an inductor. The inductor is fabricated by the method according to the first aspect. The inductor includes: a base, a center post, an upper cover, and a hollow coil.

The base is U-shaped and has an accommodating cavity.

The hollow coil is disposed in the accommodating cavity.

The center post is disposed in the accommodating cavity, and the hollow coil is sleeved onto the center post.

The top cover is abutted against a top surface of the base, a top surface of the center post, and a top surface of the hollow coil to seal the accommodating cavity and enclose the hollow coil.

The base is formed by placing a first soft magnetic powder into a base mold and performing a pressing operation, the center post is formed by placing a second soft magnetic powder into a center post mold and performing a pressing operation, and the top cover is formed by placing the third soft magnetic powder into a top cover mold and performing a pressing operation; and the base, the center post, the top cover, and the hollow coil are combined into the inductor by a hot-pressing operation.

In some embodiments, the center post is I-shaped, and the top cover is B-shaped or bar-shaped.

For details about the beneficial effects achieved by the inductor according to the second aspect and the embodiments of the second aspect, reference may be made to the beneficial effects achieved by the first aspect or any embodiment of the first aspect, which are not described herein any further.

The above description only summarizes the technical solutions of the embodiments of the present disclosure. Specific embodiments of the present disclosure are described hereinafter to better and clearer understand the technical solutions of the embodiments of the present disclosure, to practice the technical solutions based on the disclosure of the specification and to make the above and other objectives, features and advantages of the embodiments of the present disclosure more apparent and understandable.

### BRIEF DESCRIPTION OF THE DRAWINGS

FIG. 1 is a flowchart of a method for fabricating inductors according to some embodiments of the present disclosure.

FIG. 2 is a schematic structural diagram of a base according to some embodiments of the present disclosure.

FIG. 3 is a schematic structural diagram of a center post according to some embodiments of the present disclosure.

FIG. 4 is a schematic structural diagram of a top cover according to some embodiments of the present disclosure.

FIG. 5 is a schematic structural diagram of a top cover according to some embodiments of the present disclosure.

FIG. 6 is a schematic structural diagram of a hollow coil according to some embodiments of the present disclosure.

FIG. 7 is a schematic structural diagram of an inductor according to some embodiments of the present disclosure.

FIG. 8 is a schematic structural diagram of an inductor according to some embodiments of the present disclosure.

### REFERENCE NUMERALS AND DENOTATIONS THEREOF

10—base;
20—center post;
30—upper cover;
40—hollow coil; and
1—inductor.

### DETAILED DESCRIPTION OF THE EMBODIMENTS

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single
or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

The terms “example” and “embodiment” in this specification signify that the specific characteristic, structures or features described with reference to the embodiments may be covered in at least one embodiment of the present disclosure. The term “embodiment,” when used in various positions of the description, neither indicates the same embodiment, nor indicates an independent or optional embodiment that is exclusive of the other embodiments. A person skilled in the art would implicitly or explicitly understand that the embodiments described in this specification may be incorporated with other embodiments.

For the sake of brevity, only some numerical ranges are explicitly disclosed herein. However, any lower limit may be combined with any upper limit to form a range not explicitly recited. Additionally, any lower limit may be combined with any other lower limit to form a range not explicitly recited, and likewise, any upper limit may be combined with any other upper limit to form a range not explicitly recited. Furthermore, each point or individual value between the endpoints of a range is included in the range, even though not explicitly recited. Thus, each point or individual value may serve as its own lower or upper limit and may be combined with any other point or individual value or with any other lower or upper limit to form a range not explicitly recited.

The above content of the present disclosure is not intended to describe all disclosed embodiments or all implementations of the present disclosure. The following description more particularly exemplifies illustrative embodiments. Throughout the present disclosure, guidance is provided via a series of examples, which may be applied in various combinations. In each instance, the recited list serves only as a representative group and should not be interpreted as being exhaustive.

There are multiple methods for fabricating inductors, for example, as described hereinafter.

Method 1: First, a hollow coil is wound. The hollow coil is placed in a pressing mold, and then a magnetic powder is filled into the pressing mold. The magnetic powder and the hollow coil are pressed and molded in a single step using mechanical pressure to obtain an inductor.

Method 2: First, a “T”-shaped magnetic core is obtained by pressing. A coil is wound on the “T”-shaped magnetic core to from a hollow coil. The “T”-shaped magnetic core with the wound coil is placed in a pressing mold, and a magnetic powder is filled into the pressing mold and pressed and molded in a single step.

However, in Method 1 and Method 2, during the pressing operation, under the effect of pressure, the magnetic powder may flow into the interior of the coil and pierce the insulation layer of the coil, leading to a short-circuit condition. This results in poor performance of the fabricated inductor.

Furthermore, the density of the magnetic powder following the single-step pressing and molding is relatively low. For a given volume, the lower the density of the magnetic powder, the lower the inductance value of the inductor. That is, where an inductor with a higher inductance value is required, a larger inductor volume may be caused, which is not conducive to integration.

Moreover, since the magnetic powder is subjected to only a single pressing operation, in order to ensure that the density of the magnetic powder meets the requirements, the coil may be subjected to a large amount of pressure during pressing, thereby causing an increase in the amount of deformation of the coil. For a given volume, the greater the amount of deformation of the coil, the greater the impedance of the inductor. That is, where the coil is subjected to a large pressure, it may lead to excessive impedance in the inductor, which affects the inductor's performance.

Based on above description, the present disclosure provides a method for fabricating an inductor, and an inductor. By pre-pressing a soft magnetic powder to form molded parts, which are then hot-pressed together with a coil to form the inductor, the present disclosure solves the problem that, during pressing, the soft magnetic powder maybe flow into an interior of the coil, piercing an insulation layer of the coil and leading to a short-circuit and resulting in poor performance of the fabricated inductor. The performance of the inductor is thereby improved.

The technical solutions according to the present disclosure is now further described in detail with reference to the accompanying drawings and specific embodiments.

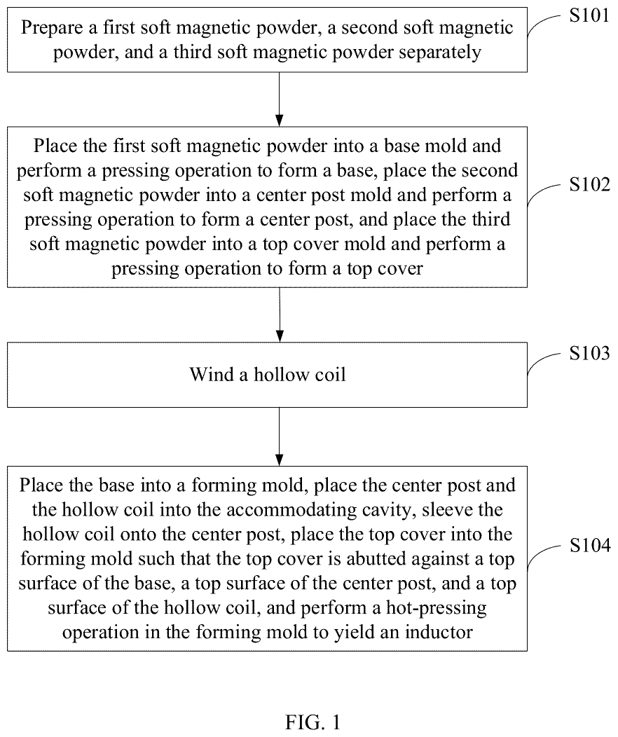

Referring to FIG. 1, which is a flowchart of a method for fabricating inductors according to some embodiments of the present disclosure, the method for fabricating inductors may be described hereinafter.

In S101, a first soft magnetic powder, a second soft magnetic powder, and a third soft magnetic powder are separately prepared.

Composition of the soft magnetic powder determines the performance of a fabricated magnetic material, such as a magnetic permeability, a magnetic induction intensity, and a high-frequency loss.

Considering that different regions of the magnetic core in an inductor have different effects on the performance of the inductor, the magnetic core of the inductor may be divided into three components during fabrication: a base, a center post, and a top cover. The base supports the center post and a hollow coil, the center post is sleeved into the hollow coil, and the top cover is configured to seal the center post and the hollow coil.

For different components, different soft magnetic powders may be used, such that the overall performance of the inductor is optimized.

The first soft magnetic powder is employed to fabricate the base, the second soft magnetic powder is employed to fabricate the center post, and the third soft magnetic powder is employed to fabricate the top cover.

The magnetic field strength and magnetic permeability of the first soft magnetic powder, the magnetic field strength and magnetic permeability of the second soft magnetic powder, and the magnetic field strength and magnetic permeability of the third soft magnetic powder may be the same or different.

Hereinafter, selection criteria for the first soft magnetic powder, the second soft magnetic powder, and the third soft magnetic powder are introduced in conjunction with main parameters of the inductor.

The main parameters of the inductor include inductance, saturation current, and direct current resistance (DCR). In different application scenarios, the requirements for these three main parameters vary.

Formulas 1 to 4 describe the relationship between the three main parameters of the inductor and the magnetic field strength and magnetic permeability of the soft magnetic powders.

$$L = \frac{u \times {A}_{e} \times {N}^{2}}{{L}_{e}} \qquad Formula 1$$

L represents the inductance, u represents the magnetic permeability, Ae represents a cross-sectional area of a magnetic path, N represents the number of turns of a hollow coil, and Le represents a length of the magnetic path.

$${I}_{s a t} = \frac{H \times {L}_{e}}{N} \qquad Formula 2$$

Isat represents the saturation current, and H represents the magnetic field strength.

$$DCR = \frac{ρ \times {L}_{a}}{{A}_{a}} \qquad Formula 3$$

DCR represents the direct current resistance, p represents a resistivity of a wire, La represents a length of the wire, and Aa represents a cross-sectional area of the wire.

$$B = u \times H \qquad Formula 4$$

B represents the magnetic induction intensity.

The wire in the above formulas refers to the wire of the hollow coil.

From Formula 1, it is apparent the inductance is directly proportional to both the magnetic permeability and the minimum cross-sectional area of the magnetic path, and inversely proportional to the length of the magnetic path.

From Formula 2, it is apparent that the saturation current is directly proportional to both the magnetic field strength and the length of the magnetic path, and inversely proportional to the number of turns of the hollow coil.

From Formula 3, it is apparent that the direct current resistance is directly proportional to both the length of the wire and the resistivity of the wire, and inversely proportional to the cross-sectional area of the wire.

From Formula 4, it is apparent that when the magnetic induction intensity is constant, the greater the magnetic permeability, the smaller the magnetic field strength, and the smaller the magnetic permeability, the greater the magnetic field strength.

For an inductor, in a case where the inductance and volume are constant, it is required that the saturation current be as large as possible and the direct current resistance be as small as possible. This means it is required that the number of turns of the hollow coil be as small as possible and the magnetic field strength be as large as possible, which also implies that the product of the magnetic permeability and the cross-sectional area of the magnetic path should be maximized.

Therefore, the magnetic permeability of the soft magnetic powder for each of the base, the center post, and the top cover may be determined based on the respective cross-sectional areas of the magnetic paths for the base, the center post, and the top cover. In a case where the minimum cross-sectional area of the magnetic path is located at the base, the first soft magnetic powder should be selected as a powder with the highest magnetic permeability among the three soft magnetic powders. In a case where the minimum cross-sectional area of the magnetic path is located at the center post, the second soft magnetic powder should be selected as a powder with the highest magnetic permeability among the three soft magnetic powders. In a case where the minimum cross-sectional area of the magnetic path is located at the top cover, the third soft magnetic powder should be selected as a powder with the highest magnetic permeability among the three soft magnetic powders. Thus, by selecting soft magnetic materials with different magnetic permeabilities to prepare the base, the center post, and the top cover, the performance of the inductor is optimized.

For example, in a case where the inductor to be fabricated has the minimum cross-sectional area of its magnetic path at the center post, then the first soft magnetic powder may be a powder with a magnetic permeability of μ₁ and a magnetic field strength of H₁, the second soft magnetic powder may be a powder with a magnetic permeability of μ₂ and a magnetic field strength of H₂, and the third soft magnetic powder can be a powder with a magnetic permeability of μ₃ and a magnetic field strength of H₃. In this case, μ₂>μ₃>μ₁, and H1>H3>H2.

Furthermore, based on cost considerations, critical regions of the inductor, such as the center post, may be made from high-cost materials to enhance core performance. Non-critical regions of the inductor, such as the base or the top cover, may be made from lower-cost materials to reduce costs.

Based on this, preparing the first soft magnetic powder, the second soft magnetic powder, and the third soft magnetic powder separately and fabricating the base, the center post, and the top cover by using these three soft magnetic powders, facilitate the optimization of the performance of the inductor, allow for customized design, and are also conducive to balancing performance and cost.

In S102, the first soft magnetic powder is placed into a base mold and a pressing operation is performed to form a base, the second soft magnetic powder is placed into a center post mold and a pressing operation is performed to form a center post, and the third soft magnetic powder is placed into a top cover mold and a pressing operation is performed to form a top cover.

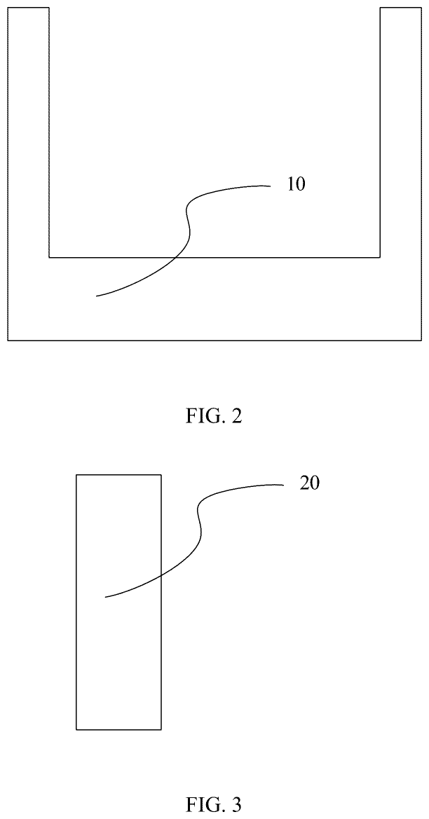

The base is U-shaped, and has an accommodating cavity. A depth and width of the accommodating cavity of the base need to be able to accommodate the center post and the hollow coil, while also satisfying a required volume of the inductor and ensuring a wall thickness and bottom thickness of the base. A schematic structural diagram of a base 10 may be as illustrated in FIG. 2.

In some embodiments, the depth of the accommodating cavity is consistent with a height of the center post. The accommodating cavity may completely accommodate the hollow coil and the center post, and a top surface of the center post is flush with a top surface of the base.

In some other embodiments, the depth of the accommodating cavity may be less than the height of the center post. In this case, the top surface of the center post is higher than the top surface of the base, and a shape of the top cover may be modified that the top cover has a concave structure, such that the top cover and the base jointly accommodate the center post and the hollow coil.

The risk of magnetic flux leakage needs to be considered in setting the wall thickness and bottom thickness of the base.

As a feasible implementation, the wall thickness of the base is greater than or equal to 50 μm to avoid magnetic flux leakage, and the bottom thickness of the base is greater than or equal to 150 μm to avoid short circuits and magnetic flux leakage.

The center post is configured to be sleeved into the hollow coil, such that a coil with a magnetic core is formed to implement the basic function of the inductor. A diameter and length of the center post may be determined according to the design requirements of the inductor. A schematic structural diagram of a center post 20 may be as illustrated in in FIG. 3.

The top cover is configured to seal the accommodating cavity to enclose the hollow coil.

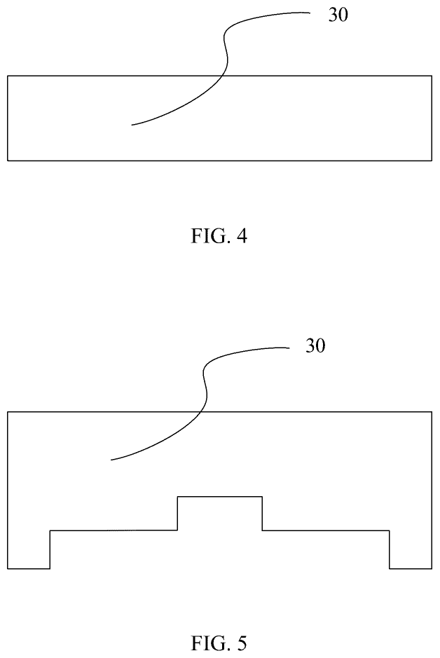

As a feasible implementation, the top cover is bar-shaped, such that in a case where the height of the center post is consistent with the depth of the accommodating cavity, the center post is abutted against the top surface of the base and the top surface of the center post, such that the accommodating cavity is sealed and the hollow coil is wrapped or enclosed. A schematic structural diagram of a top cover 30 may be as illustrated in FIG. 4.

As another feasible implementation, the top cover is B-shaped, such that when the height of the center post is greater than the depth of the accommodating cavity, the center post is abutted against the top surface of the base and the top surface of the center post, such that the accommodating cavity is sealed and the hollow coil is wrapped or enclosed. A schematic structural diagram of a top cover 30 may be as illustrated in FIG. 5.

The risk of magnetic flux leakage needs to be considered in setting a thickness of a thinnest part of the top cover.

As a feasible implementation, the thickness of the thinnest part of the top cover is greater than or equal to 150 μm to avoid short circuits and magnetic flux leakage.

The base, the center post, and the top cover are arranged separately. During pressing, for the base, the center post, and the top cover, different operating conditions may be selected for the pressing operation according to the corresponding soft magnetic material of each of the base, the center post, and the top cover, thereby ensuring that the density and performance of each of the base, the center post, and the top cover are optimized.

The greater the pressing pressure, the higher the temperature, and the longer the pressing time, the higher the density of a pressed product, which is the base, the center post, or the top cover. When pressing the base, the center post, and the top cover, the pressing conditions for the base, the center post, or the top cover should be selected according to requirements to ensure that the resulting density meets the requirements. Furthermore, the base, the center post, and the top cover still need to be combined into the inductor by a subsequent hot-pressing step. Therefore, it is also necessary to avoid excessively high density, which could lead to a poor bonding strength when the base, center post, and top cover are joined by hot pressing, consequently reducing the overall compressive strength of the inductor.

Based on this, by pre-pressing the soft magnetic powder, the base, the center post, and the top cover can be obtained. The soft magnetic powder is already formed into a specific shape by pressing before the powder comes into contact with the hollow coil, such that the soft magnetic powder is prevented from being in direct contact with the hollow coil in powder form, and thus the hollow coil is prevented from being pierced. Furthermore, dividing the magnetic core into the three parts of the base, the center post, and the top cover also allows for pressing under different conditions to ensure that the density and performance of each part are optimized, which is conducive to improving the performance of the inductor.

In S103, a hollow coil is wound.

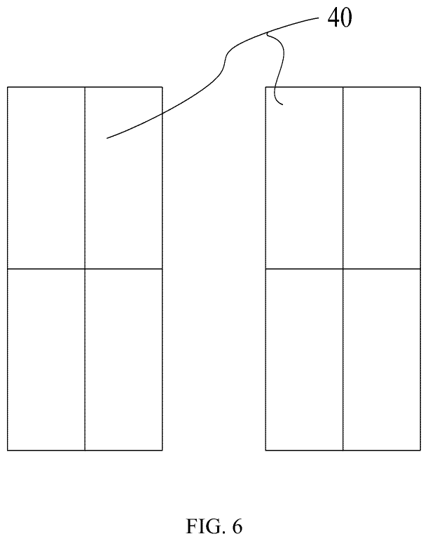

Specifically, a wire may be pre-wound on a winding tool according to requirements, such that the hollow coil is yielded. The winding method may be a single-layer winding method, a multi-layer winding method, or the like. During winding of the hollow coil, it is necessary to ensure that the winding direction is consistent. For example, clockwise winding or counter-clockwise winding may be employed, which is not limited in the present disclosure. A schematic structural diagram of a hollow coil 40 may be as illustrated in FIG. 6.

Various types of wires may be used for winding the hollow coil.

As a feasible implementation, a round wire, i.e., a wire with a circular cross-section, may be used for winding the hollow coil.

A diameter of the round wire may be from 0.015 mm to 2.0 mm.

As another feasible implementation, a flat wire, i.e., a wire with a cross-section that is approximately rectangular, may be used for winding the hollow coil.

A thickness of the flat wire may be from 0.015 mm to 0.20 mm, and a width of the flat wire may be from 0.10 mm to 0.8 mm.

The number of turns of the hollow coil may be from 1.5 turns to 100 turns. Specifically, the number of turns of the hollow coil may be defined according to a required inductance value. The larger the number of turns, the larger the inductance.

It is to be noted that S103 may be performed before S102, i.e., the hollow coil may be wound first, and then the base, the center post, and the top cover may be pressed. S102 and S103 may also be performed sequentially, i.e., the base, the center post, and the top cover are pressed first, and then the hollow coil is wound, which is not limited in the present disclosure.

In S104, the base is placed into a forming mold, the center post and the hollow coil is placed into the accommodating cavity, the hollow coil is sleeved onto the center post, the top cover is placed into the forming mold such that the top cover is abutted against a top surface of the base, a top surface of the center post, and a top surface of the hollow coil, and a hot-pressing operation is performed in the forming mold to yield an inductor.

Specifically, the base is placed into the forming mold such that a bottom of the base abuts a bottom of the forming mold. The center post and the hollow coil are placed vertically into a center position of the accommodating cavity, with the hollow coil sleeved onto the center post. The top cover is placed over the base, the accommodating cavity, and the center post, such that the shape of the top cover is simultaneously abutted against the top surface of the base, the top surface of the center post, and the top surface of the hollow coil. Thus, the top cover and the base form a sealed accommodating cavity. The center post and the hollow coil are disposed in the accommodating cavity, such that the soft magnetic material wraps or encloses the hollow coil, thereby forming an inductor.

The center post may be placed into the accommodating cavity first, and then the hollow coil may be sleeved onto the center post. The hollow coil may also be sleeved onto the center post first, and then the center post with the sleeved hollow coil may be placed together into the accommodating cavity.

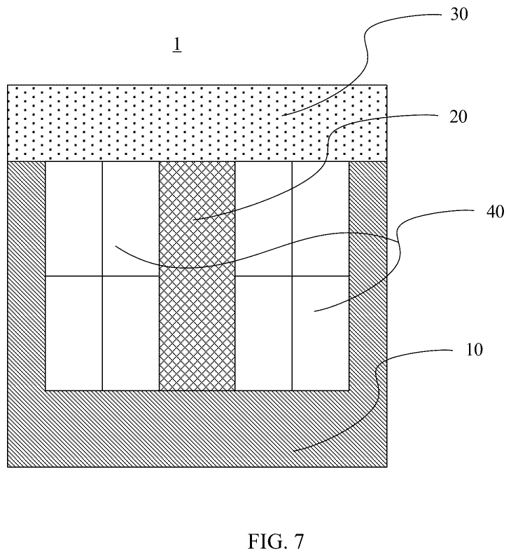

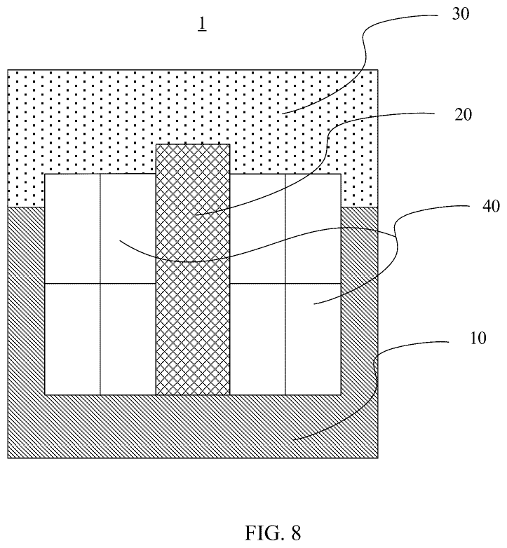

In a case where the top cover is bar-shaped, a schematic structural diagram of the inductor 1 formed by the base 10, the center post 20, the hollow coil 40, and the top cover 30 may be as illustrated in FIG. 7, the depth of the accommodating cavity is consistent with the height of the center post 20, the accommodating cavity may completely accommodate the hollow coil 40 and the center post 20, and the top surface of the center post 20 is flush with the top surface of the base 10. In a case where the top cover is B-shaped, a schematic structural diagram of the inductor 1 formed by the base 10, the center post 20, the hollow coil 40, and the top cover 30 may be as illustrated in FIG. 8, the depth of the accommodating cavity may be less than the height of the center post 20, the top surface of the enter post 20 is higher than the top surface of the base 10, and the top cover 30 has a concave structure such that the top cover 30 and the base 10 jointly accommodate the center post 20 and the hollow coil 40.

After the base, the center post, the hollow coil, and the top cover are placed into the forming mold, a hot-pressing operation may be performed in the forming mold, such that the base, the center post, the hollow coil, and the top cover are tightly connected by hot pressing to form the inductor.

The greater the pressure, the higher the temperature and the longer the pressing time of the hot-pressing operation, the higher the inductance and the higher the saturation current of the inductor, but the corresponding direct current resistance may also increase. Therefore, the pressure, temperature, and pressing time should comply with the fabrication requirements of the inductor. Furthermore, a longer pressing time may also affect the service life of the mold, and therefore, the duration of the pressing needs to be controlled to ensure that the service life of the mold may be extended.

Based on this, the base, the center post, the hollow coil, and the top cover are combined via the hot-pressing operation to form the inductor. During the hot-pressing process, since the base, the center post, and the top cover are parts pre-pressed from the soft magnetic powder, the soft magnetic material may not flow during the hot-pressing operation. The hollow coil may not come into contact with the soft magnetic powder in a powdered state, such that the probability that the soft magnetic powder pierces the hollow coil is reduced, the occurrence of short circuits is avoided, and the performance of the inductor is improved. Furthermore, the base, the center post, and the top cover may also act to hinder the deformation of the hollow coil, thereby reducing the impedance of the inductor and improving its performance.

The specifications of the inductor thus yielded may be as follows:
Length×Width: 1.0 mm×0.5 mm to 20 mm×20 mm;
Thickness: 0.5 mm to 20 mm;
Inductance: 0.05 μH to 100 μH;
DCR: 1 mohm (mΩ) to 10 ohms (Ω);
Rated Current: 0.1 mA to 100 A.

In the embodiments of the present disclosure, fabricating the first soft magnetic powder, the second soft magnetic powder, and the third soft magnetic powder separately and fabricating the base, the center post, and the top cover from these three soft magnetic powders, facilitate the optimization of the performance of the inductor, allow for customized design, and are also conducive to balancing performance and cost. By pre-pressing the soft magnetic powder, the base, the center post, and the top cover may be yielded. Furthermore, dividing the magnetic core into the three parts of the base, the center post, and the top cover also allows for pressing under different conditions to ensure that the density and performance of each part are optimized, which is conducive to improving the performance of the inductor. The base, the center post, the hollow coil, and the top cover are combined via the hot-pressing operation to form the inductor. During the hot-pressing process, since the base, the center post, and the top cover are parts pre-pressed from the soft magnetic powder, the soft magnetic material may not flow during the hot-pressing operation. The hollow coil may not come into contact with the soft magnetic powder in a powdered state, such that the probability that the soft magnetic powder pierces the hollow coil is reduced, the occurrence of short circuits is avoided, and the performance of the inductor is improved.

Furthermore, the pre-pressed and formed soft magnetic material parts undergo another hot-pressing step. The density is increased after the hot-pressing. For the same volume, this can increase the inductance value of the inductor, thereby further improving the inductor's performance. Moreover, since the base, the center post, and the top cover are pre-pressed soft magnetic material parts, they may act to hinder the deformation of the hollow coil during hot pressing, thereby reducing the impedance of the inductor and improving its performance.

Based on the foregoing exemplary description, an insulating paint may also be sprayed onto the inductor. A laser process may be used to remove the insulating paint at the positions of the hollow coil on a bottom of the base, and then terminals may be formed by electroplating to yield the finished inductor.

Based on the above exemplary description, for the pressing operation, a pressure per unit area is from 20 kg/mm² to 60 kg/mm², a mold cavity temperature is from 20° C. to 100° C., and a pressing time is from 0.1 s to 1 s.

In a case where the pressure per unit area of the pressing operation is 20 kg/mm², it is ensured that the soft magnetic powder is molded. In a case where the pressure per unit area is less than 20 kg/mm², the soft magnetic powder may not be successfully molded.

In a case where the pressure per unit area of the pressing operation is 60 kg/mm², on the basis of ensuring that the soft magnetic powder is molded, a bonding force between the soft magnetic powder particles may be increased, such that the base, center post, and top cover are less prone to cracking after the pressing operation, thereby ensuring smooth progression of subsequent processes. Further, the density of the soft magnetic powder is also increased, such that the powder particles are tightly bonded to meet the product design requirements of the inductor. In a case where the pressure per unit area is greater than 60 kg/mm², the base, the center post, and the top cover may have excessively high densities, and thus may have a risk of cracking.

In a case where the mold cavity temperature of the pressing operation is 20° C., it is ensured that the soft magnetic powder is molded, and no heating is required, which saves costs. In a case where the mold cavity temperature is less than 20° C., the soft magnetic powder may not be successfully molded.

In a case where the mold cavity temperature of the pressing operation is 100° C., on the basis of ensuring that the soft magnetic powder is molded, the bonding force between the soft magnetic powder particles may be increased, such that the base, center post, and top cover are less prone to cracking after the pressing operation, thereby ensuring the smooth progression of subsequent processes. In a case where the mold cavity temperature is greater than 100° C., the wear and tear on the mold may be increased, thereby leading to increased costs.

In a case where the pressing time of the pressing operation is 0.1 s, it is ensured that the soft magnetic powder is molded. Furthermore, the pressure per unit area and the mold cavity temperature may be increased accordingly. In a case where the pressing time is less than 0.1 s, the soft magnetic powder may not be successfully molded.

In a case where the pressing time of the pressing operation is 1 s, the density of the soft magnetic powder may be increased, such that the powder particles are tightly bonded to meet the product design requirements of the inductor. In a case where the pressing time is greater than 1 s, the base, the center post, and the top cover may have excessively high densities, and thus may have a risk of cracking.

During setting the pressure per unit area, the mold cavity temperature, and the pressing time for the pressing operation, these parameters may be coordinated. For example, in a case where the mold cavity temperature is relatively low, the pressure per unit area and the pressing time may be increased. In a case where the mold cavity temperature is relatively high, the pressure per unit area and the pressing time may be reduced, such that the base, center post, and top cover are properly molded.

In some embodiments, for the pressing operation, the pressure per unit area is 40 kg/mm², the mold cavity temperature is 30° C., and the pressing time is 0.3 s, such that a density of the base, the center post, and the top cover formed by the pressing operation is in a range of 5.5 g/mm³ to 6.5 g/mm³.

The greater the pressure, the higher the temperature, and the longer the pressing time of the pressing operation, and hence the higher the densities of the base, the center post, and the top cover. However, because the base, the center post, and the top cover need to undergo a subsequent hot-pressing operation following the initial pressing operation, in a case where the densities of the base, the center post, and the top cover is too high following the initial pressing, the bonding force therebetween during the subsequent hot-pressing may be reduced. This leads to a decrease in the overall compressive strength of the inductor. Therefore, the densities following the initial pressing operation needs to be controlled to be between 5.5 g/mm³ and 6.5 g/mm³. In a case where the densities are greater than 6.5 g/mm³, the parts are prone to cracking upon the hot-pressing operation. In a case where the densities are less than 5.5 g/mm³, the strengths of the base, the center post, and the top cover are low, and thus the base, the center post, and the top cover are prone to damages and are not suitable for mass production. The base, the center post, and the top cover formed under the conditions of a pressure per unit area of 40 kg/mm², a mold cavity temperature of 30° C., and a pressing time of 0.3 s have a density within this range.

Based on the above exemplary description, for the hot-pressing operation, the pressure per unit area is from 40 kg/mm² to 80 kg/mm², the mold cavity temperature is from 150° C. to 220° C., and the pressing time is from 40 s to 120 s.

In a case where the pressure per unit area of the hot-pressing operation is 40 kg/mm², it is ensured that the base, the center post, and the top cover are bonded to seal the accommodating cavity. In a case where the pressure per unit area is less than 40 kg/mm², the base, center post, and top cover may fail to achieve a tight bonding.

In a case where the pressure per unit area of the hot-pressing operation is 80 kg/mm², on the basis of ensuring the bonding of the base, the center post, and top cover, a bonding force between the soft magnetic powder particles may be increased, and the densities of the base, the center post, and the top cover following hot-pressing may be increased, thereby increasing the inductance of the inductor. In a case where the pressure per unit area is greater than 80 kg/mm², the base, the center post, and the top cover may crack, leading to a failure of the inductor.

In a case where the mold cavity temperature of the hot-pressing operation is 150° C., it is ensured the base, the center post, and the top cover are bonded to seal the accommodating cavity. In a case where the mold cavity temperature is less than 150° C., the base, the center post, and the top cover may fail to achieve a tight bonding.

In a case where the mold cavity temperature of the hot-pressing operation is 220° C., on the basis of ensuring the bonding of the base, the center post, and the top cover, the bonding force between the soft magnetic powder particles may be increased, and the densities of the base, the center post, and the top cover following hot-pressing may be increased, thereby increasing the inductance of the inductor. In a case where the mold cavity temperature is greater than 220° C., the wear and tear on the mold may be increased, thereby leading to increased costs.

In a case where the pressing time of the hot-pressing operation is 40 s, it is ensured that the base, the center post, and the top cover are bonded to seal the accommodating cavity. In a case where the pressing time is less than 40 s, the base, the center post, and the top cover may fail to achieve a tight bonding.

In a case where the pressing time of the hot-pressing operation is 120 s, on the basis of ensuring the bonding of the base, the center post, and the top cover, the bonding force between the soft magnetic powder particles may be increased, and the densities of the base, the center post, and the top cover following hot-pressing may be increased, thereby increasing the inductance of the inductor. In a case where the pressing time is greater than 120 s, the base, the center post, and the top cover may have excessively high densities, and thus may have a risk of cracking.

Preferably, for the hot-pressing operation, the pressure per unit area is 60 kg/mm², the mold cavity temperature is 180° C., and the pressing time is 80 s.

Under these conditions, the effect of the hot-pressing is optimal. The base, the center post, and the top cover are tightly bonded, and the densities meet the design requirements of the inductor, such that the inductance is improved, and thus the performance of the inductor is improved.

Based on the above exemplary description, the method for winding the hollow coil may be as follows.

The hollow coil is formed by winding a wire on a metal sleeve using an interpolation winding method.

A diameter of the metal sleeve is greater than a diameter of the center post, such that the hollow coil is smoothly sleeved onto the center post.

In the related art, winding is performed on a T-shaped magnetic core. Because the strength of the magnetic core is low and thus the magnetic core prone to breaking, clamping jaws are needed to hold the wire, and the clamping jaws revolve around the magnetic core to perform the winding. The position where the clamping jaws hold the wire may easily cause an insulation layer of the wire to rupture. During winding on a metal sleeve using the interpolation method, the wire is wound on the metal sleeve, and a jig drives the metal sleeve to revolve. No clamping jaws are needed to hold the wire, which reduces the risk of rupturing the insulation layer of the wire, thereby further contributing to the improved performance of the inductor.

Based on the above exemplary description, a target soft magnetic powder primarily includes a resin material and a soft magnetic metal material.

The target soft magnetic powder includes one or more from a group of: a first soft magnetic powder, a second soft magnetic powder, and a third soft magnetic powder.

The addition of the resin material may improve the bonding strength, enhance the magnetic properties, and increase the heat resistance and chemical stability of the target soft magnetic powder.

Particle sizes of the resin material and the soft magnetic metal material are from 1 μm to 60 μm.

A particle size of the target soft magnetic powder is from 50 μm to 250 μm.

A relative magnetic permeability of the target soft magnetic powder is from 10 to 100.

Preferably, by weight, a content of the resin material is from 1% to 10%, and a content of the soft magnetic metal material is from 90% to 99%.

The resin material includes one or more selected from the group consisting of an epoxy resin, an amino resin, a polyamide resin, and a phenolic resin.

In some examples, the resin material is an epoxy resin. The epoxy resin has high mechanical strength, good adhesion, and good impact resistance, which improves the dielectric properties of the inductor.

In other examples, the resin material is a mixture of an epoxy resin and an amino resin. The amino resin has high hardness, scratch resistance, low moisture absorption, and high temperature resistance. The amino resin, when mixed with the epoxy resin, gains increased rigidity and reduced moisture absorption, which improves the operational performance of the inductor.

Exemplarily, contents of the amino resin and the epoxy resin are: by weight, 10% to 30% of amino resin and 70% to 90% epoxy resin.

Based on different requirements for fabricating an inductor, the contents of the epoxy resin and the amino resin may be adjusted. For example, in a case where the inductor needs to operate in a high-frequency or high-temperature environment, the content of the amino resin may be increased, and the content of the epoxy resin may be decreased, such as a resin material made from a mixture of 70% epoxy resin and 30% amino resin by weight.

The soft magnetic metal material includes one or more selected from the group consisting of a carbonyl iron powder, an iron-silicon-aluminum powder, an iron-silicon powder, an iron-nickel powder, an iron-nickel-molybdenum powder, an amorphous powder, and a nanocrystalline powder. A content of any one of these powders needs to be greater than or equal to 10% of a total content of the soft magnetic metal material. For example, in a case where the soft magnetic metal material consists of the carbonyl iron powder and the iron-silicon-aluminum powder, and the content of the carbonyl iron powder is 10% by weight, then the content of the iron-silicon-aluminum powder is 90% by weight.

In some examples, the soft magnetic metal material is a carbonyl iron powder. The carbonyl iron powder has high stability, which reduces the high-frequency loss of the inductor. In addition, the carbonyl iron powder has good packing properties and excellent flowability, making it suitable for pressing complex-shaped magnetic cores. Furthermore, the carbonyl iron powder has good mechanical strength, which reduces the risk of the magnetic core cracking, reduces the cost.

In other examples, the soft magnetic metal material is a mixture of a carbonyl iron powder and an iron-silicon-aluminum powder. The iron-silicon-aluminum powder has low hysteresis coefficient, high magnetic induction intensity, low magnetic loss, and high stability.

When mixed with carbonyl iron powder, the iron-silicon-aluminum powder improves the performance of the inductor.

Exemplarily, by weight, the content of the carbonyl iron powder is from 10% to 90%, and the content of the iron-silicon-aluminum powder is from 10% to 90%.

Based on the requirements for magnetic permeability and magnetic field strength during fabricating an inductor, the contents of the carbonyl iron powder and the iron-silicon-aluminum powder may be adjusted, such that the magnetic permeability and the magnetic field strength of the target soft magnetic powder meet the requirements.

Furthermore, the contents of the carbonyl iron powder and the iron-silicon-aluminum powder may also be adjusted depending on different application scenarios. For example, in a case where a high-inductance inductor is required, the content of the carbonyl iron powder may be increased, such as a soft magnetic metal material made from a mixture of 70% carbonyl iron powder and 30% iron-silicon-aluminum powder by weight. For broadband applications, the contents of the carbonyl iron powder and the iron-silicon-aluminum powder may be balanced, such as a soft magnetic metal material made from a mixture of 50% carbonyl iron powder and 50% iron-silicon-aluminum powder by weight.

In yet other examples, the soft magnetic metal material is a mixture of an iron-nickel powder, an iron-nickel-molybdenum powder, and an amorphous powder. The iron-nickel powder has high magnetic permeability, low coercivity, and may be adapt to different temperatures. The iron-nickel-molybdenum powder has the characteristics of low hysteresis and low eddy current loss. The amorphous powder has high strength, high hardness, wear resistance, corrosion resistance, low hysteresis, and high viscosity coefficient. In a case where the iron-nickel powder, the iron-nickel-molybdenum powder, and the amorphous powder are mixed, the stability, anti-interference capability, and service life of the inductor are improved while the performance is ensured.

Exemplarily, by weight, a content of the iron-nickel powder is from 10% to 40%, a content of the iron-nickel-molybdenum powder is from 20% to 60%, and a content of the amorphous powder is from 20% to 70%.

Based on the requirements on the magnetic permeability and magnetic field strength during fabricating an inductor, the contents of the iron-nickel powder, the iron-nickel-molybdenum powder, and the amorphous powder may be adjusted, such that the magnetic permeability and the magnetic field strength of the target soft magnetic powder meet the requirements.

Furthermore, the contents may also be adjusted depending on different application scenarios. For example, in a case where an inductor suitable for high-frequency scenarios is required, the contents of the amorphous powder and the iron-nickel-molybdenum powder may be increased, such as a soft magnetic metal material made from a mixture of 70% amorphous powder, 20% iron-nickel-molybdenum powder, and 10% iron-nickel powder by weight. In a case where an inductor suitable for high-power scenarios is required, the content of the iron-nickel powder may be increased, such as a soft magnetic metal material made from a mixture of 40% amorphous powder, 50% iron-nickel powder, and 10% iron-nickel-molybdenum powder by weight.

Exemplarily, the present disclosure also provides an inductor, wherein the inductor is fabricated by the method for fabricating inductors according to the embodiments as illustrated in FIG. 1 to FIG. 8. The inductor includes: a base, a center post, a top cover, and a hollow coil.

The base is U-shaped and defines an accommodating cavity.

The hollow coil is disposed in the accommodating cavity.

The center post is disposed in the accommodating cavity, and the hollow coil is sleeved onto the center post.

The top cover is abutted against a top surface of the base, a top surface of the center post, and a top surface of the hollow coil to seal the accommodating cavity and enclose the hollow coil.

The base is formed by pressing a first soft magnetic powder; the center post is formed by pressing a second soft magnetic powder, and the top cover is formed by pressing a third soft magnetic powder; and the base, the center post, the top cover, and the hollow coil are combined into the inductor by a hot-pressing operation.

In some embodiments, the center post is I-shaped, and the top cover is B-shaped or bar-shaped.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A method for fabricating inductors, comprising:
preparing a first soft magnetic powder, a second soft magnetic powder, and a third soft magnetic powder separately;
placing the first soft magnetic powder into a base mold and performing a pressing operation to form a base, wherein the base is U-shaped and has an accommodating cavity;
placing the second soft magnetic powder into a center post mold and performing a pressing operation to form a center post;
placing the third soft magnetic powder into a top cover mold and performing a pressing operation to form a top cover, wherein the top cover is configured to seal the accommodating cavity;
winding a hollow coil;
placing the base into a forming mold, placing the center post and the hollow coil into the accommodating cavity, sleeving the hollow coil onto the center post, and placing the top cover into the forming mold such that the top cover is abutted against a top surface of the base, a top surface of the center post, and a top surface of the hollow coil; and
performing a hot-pressing operation in the forming mold to yield an inductor.

2. The method according to claim 1, wherein for the each pressing operation, a pressure per unit area is from 20 kg/mm² to 60 kg/mm², a mold cavity temperature is from 20° C. to 100° C., and a pressing time is from 0.1 s to 1 s.

3. The method according to claim 2, wherein the pressure per unit area is 40 kg/mm², the mold cavity temperature is 30° C., and the pressing time is 0.3 s, such that a density of the base, the center post, and the top cover formed by the pressing operation is in a range of 5.5 g/mm³ to 6.5 g/mm³.

4. The method according to claim 1, wherein for the hot-pressing operation, a pressure per unit area is from 40 kg/mm² to 80 kg/mm², a mold cavity temperature is from 150° C. to 220° C., and a pressing time is from 40 s to 120 s.

5. The method according to claim 1, wherein winding the hollow coil comprises:
winding the hollow coil on a metal sleeve by interpolation winding, wherein a diameter of the metal sleeve is greater than a diameter of the center post.

6. The method according to claim 1, wherein each of the first soft magnetic powder, the second soft magnetic powder, and the third soft magnetic powder comprises a resin material and a soft magnetic metal material;
the resin material comprises one or more selected from the group consisting of an epoxy resin, an amino resin, a polyamide resin, and a phenolic resin; and
the soft magnetic metal material comprises one or more selected from the group consisting of a carbonyl iron powder, an iron-silicon-aluminum powder, an iron-silicon powder, an iron-nickel powder, an iron-nickel-molybdenum powder, an amorphous powder, and a nanocrystalline powder.

7. The method according to claim 6, wherein a content of the resin material is from 1% to 10% by weight.

8. The method according to claim 1, wherein a wall thickness of the base is greater than or equal to 50 μm, a bottom thickness of the base is greater than or equal to 150 μm, and a thickness of a thinnest part of the top cover is greater than or equal to 150 μm.

9. The method according to claim 1, wherein a depth of the accommodating cavity is consistent with a height of the center post, the accommodating cavity completely accommodates the hollow coil and the center post, and the top surface of the center post is flush with the top surface of the base.

10. The method according to claim 1, wherein a depth of the accommodating cavity is less than a height of the center post, the top surface of the center post is higher than the top surface of the base, and the top cover has a concave structure such that the top cover and the base jointly accommodate the center post and the hollow coil.

11. An inductor, comprising: a base, a center post, a top cover, and a hollow coil; wherein
the base is U-shaped and has an accommodating cavity;
the hollow coil is disposed in the accommodating cavity;
the center post is disposed in the accommodating cavity, wherein the hollow coil is sleeved onto the center post;
the top cover is abutted against a top surface of the base, a top surface of the center post, and a top surface of the hollow coil to seal the accommodating cavity and enclose the hollow coil; and
the base is formed by placing a first soft magnetic powder into a base mold and performing a pressing operation, the center post is formed by placing a second soft magnetic powder into a center post mold and performing a pressing operation, and the top cover is formed by placing the third soft magnetic powder into a top cover mold and performing a pressing operation; and the base, the center post, the top cover, and the hollow coil are combined into the inductor by a hot-pressing operation.

12. The inductor according to claim 11, wherein the center post is I-shaped, and the top cover is B-shaped or bar-shaped.

13. The inductor according to claim 11, wherein a depth of the accommodating cavity is consistent with a height of the center post, the accommodating cavity completely accommodates the hollow coil and the center post, and the top surface of the center post is flush with the top surface of the base.

14. The inductor according to claim 11, wherein a depth of the accommodating cavity is less than a height of the center post, the top surface of the center post is higher than the top surface of the base, and the top cover has a concave structure such that the top cover and the base jointly accommodate the center post and the hollow coil.

15. The inductor according to claim 11, wherein for the each pressing operation, a pressure per unit area is from 20 kg/mm² to 60 kg/mm², a mold cavity temperature is from 20° C. to 100° C., and a pressing time is from 0.1 s to 1 s.

16. The inductor according to claim 15, wherein the pressure per unit area is 40 kg/mm², the mold cavity temperature is 30° C., and the pressing time is 0.3 s, such that a density of the base, the center post, and the top cover formed by the pressing operation is in a range of 5.5 g/mm³ to 6.5 g/mm³.

17. The inductor according to claim 11, wherein for the hot-pressing operation, a pressure per unit area is from 40 kg/mm² to 80 kg/mm², a mold cavity temperature is from 150° C. to 220° C., and a pressing time is from 40 s to 120 s.

18. The inductor according to claim 11, wherein each of the first soft magnetic powder, the second soft magnetic powder, and the third soft magnetic powder comprises a resin material and a soft magnetic metal material;
the resin material comprises one or more selected from the group consisting of an epoxy resin, an amino resin, a polyamide resin, and a phenolic resin; and
the soft magnetic metal material comprises one or more selected from the group consisting of a carbonyl iron powder, an iron-silicon-aluminum powder, an iron-silicon powder, an iron-nickel powder, an iron-nickel-molybdenum powder, an amorphous powder, and a nanocrystalline powder.

19. The inductor according to claim 18, wherein a content of the resin material is from 1% to 10% by weight.

20. The inductor according to claim 11, wherein a wall thickness of the base is greater than or equal to 50 μm, a bottom thickness of the base is greater than or equal to 150 μm, and a thickness of a thinnest part of the top cover is greater than or equal to 150 μm.
